(19) United States
(12) Patent Application Publication
(10) Pub. No.: US 2019/0356854 A1
(43) Pub. Date: Nov. 21, 2019

(54) PORTABLE ELECTRONIC DEVICE AND IMAGE CAPTURING METHOD THEREOF

(71) Applicant: Chiun Mai Communication Systems, Inc., New Taipei (TW)

(72) Inventor: CHENG-KUO YANG, New Taipei (TW)

(21) Appl. No.: 16/418,421

(22) Filed: May 21, 2019

(30) Foreign Application Priority Data
May 21, 2018 (CN) 201810488742.1

(51) Int. Cl. H04N 5/232

(52) U.S. Cl. CPC H04N 5/23245; H04N 5/23238; H04N 5/23219

(57) ABSTRACT

A portable electronic device includes a camera module and a processor. The camera module includes capturing modes of a first mode and a second mode. A view angle of the second mode is wider than a view angle of the first mode. The camera module is initiated in the first mode and captures an image transferring to the processor, the processor identifies whether faces exist in the image, if the processor identifies that there are more than one faces in the image and at least one of the faces is incomplete in the image, the processor controls the camera module to switch the capturing mode to the second mode. An image capturing method of the portable electronic device is also provided.

### FIELD

The subject matter herein generally relates to a portable electronic device and an image capturing method of the portable electronic device which can automatically switch capturing modes.

### BACKGROUND

Portable electronic devices may include a camera module for capturing images, such as the user may use the camera module of the portable electronic device for taking selfies. However, a wide angle of the camera module of the portable electronic device is limited, when images of multiple faces are being captured, faces near the edges of the image may be partially missing, resulting poor image quality.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a portable electronic device.

FIG. 2 is a flow chart of one embodiment of an image capturing method of the portable electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

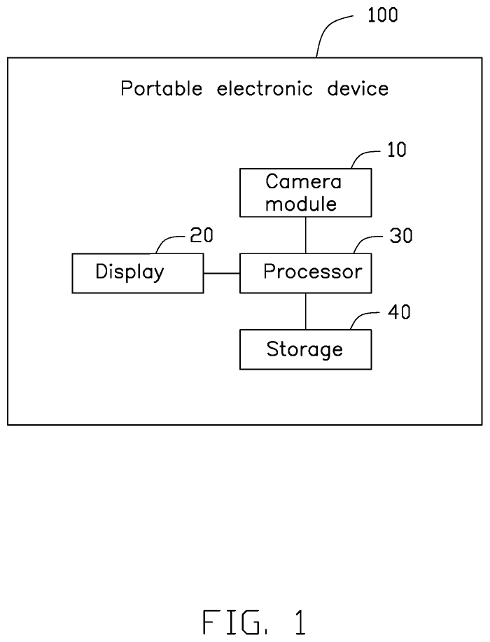

FIG. 1 illustrates one embodiment of a portable electronic device 100. The portable electronic device 100 can be, but is not limited to, a computer, a server computer, a tablet computer, a mobile phone, a personal digital assistant, a consumer portable electronic device, a distributed computing environment employing the aforesaid system, or other device. The portable electronic device 100 includes a camera module 10, a display 20, a processor 30, and a storage 40. The camera module 10, the display 20, and the storage 40 are electrically connected to the processor 30. Furthermore, the processor 30 is electrically connected to other electronic elements of the portable electronic device 100 for processing data and information of all electronic elements connected.

The camera module 10 is configured to capture images. The display 20 is configured to provide a user interface and a captured view of the camera module 10. In at least one embodiment, the camera module 10 can be arranged in front or back of the portable electronic device 100. When the camera module 10 is arranged in front of the portable electronic device 100, the camera module 10 and the display 20 are in a same side of the portable electronic device 100. When the camera module 10 is arranged in back of the portable electronic device 100, the camera module 10 and the display 20 are on opposite sides of the portable electronic device 100. In at least one embodiment, the camera module 10 includes more than one capturing modes, these capturing modes being a standard mode and a panorama mode. A capturing angle of view of the panorama mode is wider than a capturing angle of view of the standard mode. The capturing angle of view means that everything across and up to certain limits which are visible in a scene can be captured in an image, the certain limits being dependent on an angle range of the camera module 10. The display 20 can be operated by the user through the user interface to control the camera module 10. The display 20 can be a touch control display for detecting touch operations from the user. In addition, the display 20 may respond to touch operations by an object, such as a stylus, an indicator, a pen, a finger, a hand and/or a fingernail, etc.

In another embodiment, the camera module 10 can include dual camera lenses, such as a standard lens and a wide-angle lens. The standard lens is applied to the standard mode, and the wide-angle lens is applied to a wide-angle mode. A capturing angle of view of the wide-angle mode corresponding to the wide-angle lens is wider than a capturing angle of view available in the standard mode corresponding to the standard lens.

The processor 30 is configured to identify whether faces exist in the image captured by the camera module 10 and can switch between the capturing modes. The camera module 10 is configured to provide the captured view and capture an image, the processor 30 is configured to identify whether faces exist in the image. In at least one embodiment, the processor 30 is configured to identify faces from the image and determine whether the identified faces are complete and unbroken. In at least one embodiment, the faces may be incomplete when the faces are close to edges of the image, then the processor 30 will determine that that such faces are incomplete. The processor 30 is configured to switch the capturing modes between the standard mode and the panorama mode (the wide-angle mode) as required. When the camera module 10 includes a single camera lens, the processor 30 is also configured to switch the capturing modes between the standard mode and the panorama mode. When the camera module 10 includes dual camera lenses, the processor 30 is configured to switch the capturing modes between the standard mode and the wide-angle mode. In at least one embodiment, when the processor 30 identifies that there is only one face in the image, then the processor 30 controls the camera module 10 to be in the standard mode for capturing images. When the processor 30 identifies that there are more than one faces in the image and the faces are unbroken, then the processor 30 controls the camera module 10 to be in the standard mode for capturing images. When the processor 30 identifies that there are more than one faces in the image and at least one of the faces is broken, then the processor 30 controls the camera module 10 to be in the panorama mode or the wide-angle mode for capturing images to capture every face in the image completely. The processor 30 can be a central processing unit, a single chip microcomputer, or other micro integrated circuits.

The storage 40 is configured to store the images captured by the camera module 10. The storage 40 can be a memory of the portable electronic device 100 or an external storage device, such as a Smart Media Card, a Secure Digital Card, or a Random-Access Memory (RAM), connected to the portable electronic device 100.

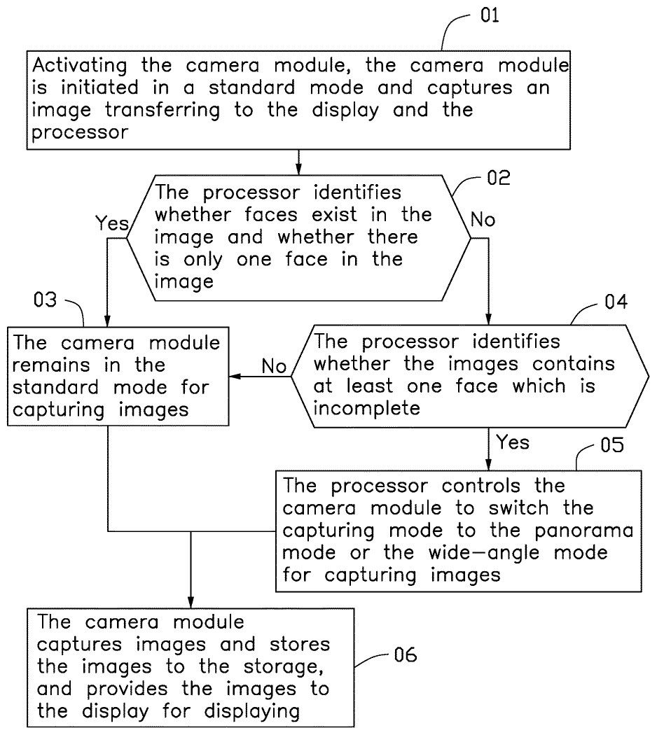

In FIG. 2, a flowchart in accordance with an embodiment is disclosed. The image capturing method of the portable electronic device 100 can be carried out using the configurations illustrated in FIG. 1, for example, and various elements of these figures are referenced in the method. Each block shown in FIG. 2 represents one or more processes, methods or subroutines, carried out in the method. Furthermore, the illustrated order of blocks is by example only and the order of the blocks can change. Additional blocks may be added or fewer blocks may be utilized, without departing from this disclosure. The method can begin at block 01.

At block 01, activating the camera module 10. The camera module 10 is initiated in a standard mode and provides a captured view to the display 20 to display and to the processor 30, the camera module 10 captures an image and transfers to the processor 30. The captured view and the image are viewable on the display 20. In at least one embodiment, the camera module 10 includes capturing modes of the standard mode and a panorama mode. In another embodiment, the camera module 10 includes dual camera lenses, which include a standard lens and a wide-angle lens. The standard lens is applied to the standard mode, and the wide-angle lens is applied to a wide-angle mode. In at least one embodiment, a default capturing mode of the camera module 10 is the standard mode.

At block 02, the processor 30 identifies whether faces exist in the image and whether there is only one face in the image. When the processor 30 identifies there is only one face in the image, the procedure goes to block 03. When the processor 30 identifies there are more than one faces in the image, the procedure goes to block 04.

At block 03, the camera module 10 remains in the standard mode for capturing images.

At block 04, the processor 30 identifies whether the image contains at least one face which is incomplete. When the processor 30 identifies all the faces in the image are complete, the procedure goes back to block 03. When the processor 30 identifies there is at least one face in the image is incomplete, the procedure goes to block 05.

At block 05, the processor 30 controls the camera module 10 to switch the capturing mode from the standard mode to the panorama mode or the wide-angle mode for capturing images. When the camera module 10 switches the capturing mode to the panorama mode or the wide-angle mode, all faces in the image can be complete.

At block 06, the camera module 10 captures images and stores the images to the storage 50, and further provides the images to the display 20 for displaying.

The portable electronic device 100 identifies whether there an incomplete face in the image of the camera module 10, and switches the standard mode, the panorama mode or the wide-angle mode for capturing images accordingly. Therefore, all faces in the image are complete and a better image can be captured.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A portable electronic device comprising:
a camera module comprising capturing modes of a first mode and a second mode, a view angle of the second mode being wider than a view angle of the first mode; and
a processor;
wherein the camera module is initiated in the first mode and captures an image transferring to the processor, the processor identifies whether faces exist in the image, if the processor identifies that there are more than one faces in the image and at least one of the faces is incomplete in the image, the processor controls the camera module to switch the capturing mode to the second mode.

2. The portable electronic device as claimed in claim 1, wherein when the processor identifies there is single face in the image, the camera module remains the capturing mode in the first mode.

3. The portable electronic device as claimed in claim 1, wherein when the processor identifies there are more than one faces in the image and all the faces are complete, the camera module remains the capturing mode in the first mode.

4. The portable electronic device as claimed in claim 1, wherein the first mode is a standard mode, the second mode is a panorama mode.

5. The portable electronic device as claimed in claim 1, wherein the camera module includes a standard lens and a wide-angle lens, the camera module captures images through the standard lens in the first mode and through the wide-angle lens in the second mode.

6. An image capturing method applied in a portable electronic device, the portable electronic device comprising a camera module for capturing images, the image capturing method comprising:
capturing an image in a first mode;
identifying whether faces exist in the image; and
switching a capturing mode from the first mode to a second mode if identifying that there are more than one faces in the image and at least one of the faces in the image is incomplete, a view angle of the second mode being wider than a view angle of the first mode.

7. The image capturing method as claimed in claim 6, further comprising:
remaining the capturing mode in the first mode when there is a single face in the image.

8. The image capturing method as claimed in claim 6, further comprising:
remaining the capturing mode in the first mode when there are more than one faces in the image and all the faces are complete.

9. The image capturing method as claimed in claim 6, wherein the first mode is a standard mode, the second mode is a panorama mode.

10. The image capturing method as claimed in claim 6, further comprising:
capturing images through a standard lens in the first mode and through a wide-angle lens in the second mode.
